(19) United States
(12) Patent Application Publication
(10) Pub. No.: US 2014/0257733 A1
(43) Pub. Date: Sep. 11, 2014

(54) COORDINATE MEASUREMENT DEVICE AND METHOD FOR CHECKING INSTALLATION POSITION OF EACH PROBE OF STAR PROBER

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHIH-KUANG CHANG, New Taipei (TW); ZHONG-KUI YUAN, Shenzhen (CN); YU-HUA XU, Shenzhen (CN); XIAO-GUANG XUE, Shenzhen (CN); DONG-SHENG LIU, Shenzhen (CN); NA YU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/101,340

(22) Filed: Dec. 10, 2013

(30) Foreign Application Priority Data
Mar. 7, 2013 (CN) 2013100724066

(51) Int. Cl. G01B 21/04

(52) U.S. Cl. CPC G01B 21/042
USPC 702/95

(57) ABSTRACT

In a method for checking installation positions of probes of a star prober using a coordinate measurement device, the star prober is fixed vertically on a platform and supported by a movable arm, and a standard ball placed on the platform. The first probe measures a first point on a top surface of the standard ball, and the second probe measures a second point on the top surface of the standard ball. An X-Y coordinate system based on the first and second points is established, and a value of any deviation angle between the first probe and the second probe is calculated based on the X-Y coordinate system. The information is displayed for indicating whether the installations of the first and second probes are precise or not according to any deviation value, and the respective installations of the other individual probes are checked against the X-Y coordinate system.

### BACKGROUND

1. Technical Field

Embodiments of the present disclosure relate to coordinate measurement machines, and particularly to a coordinate measurement device and method for checking an installation position of each probe of a star prober.

2. Description of Related Art

Coordinate measurement machines can be used to perform a variety of measurement and coordinates acquisition tasks. In a coordinate measurement machine, a movable arm can be connected to a star prober for measuring various dimensions of workpieces. The star prober includes five probes to conveniently measure different surfaces of a workpiece. To obtain precision and accuracy of the measurements, each of the probes installed on the star prober must be calibrated before the star prober is used in the measurement machine. However, it is time-consuming and difficult to precisely check an installation position of each probe of the star prober manually. Therefore, there is room for improvement within the art.

### BRIEF DESCRIPTION OF THE DRAWINGS

FIG. 1 is a block diagram of one embodiment of a coordinate measurement device including a probe checking system.

FIG. 2 is a flowchart of one embodiment of a method for checking installation positions of a first probe and a second probe installed on a star prober included in the coordinate measurement device of FIG. 1.

FIG. 3 is a flowchart of one embodiment of a method for checking an installation position of a third probe installed on the star prober.

FIG. 4 is a flowchart of one embodiment of a method for checking an installation position of a fourth probe installed on the star prober.

FIG. 5 is a flowchart of one embodiment of a method for checking an installation position of a fifth probe installed on the star prober.

FIG. 6 shows a schematic diagram of the star prober.

FIG. 7 shows a schematic diagram of an X-Y coordinate system indicating installation positions of probes of the star prober.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of a non-transitory computer-readable medium include CDs, DVDs, flash memory, and hard disk drives.

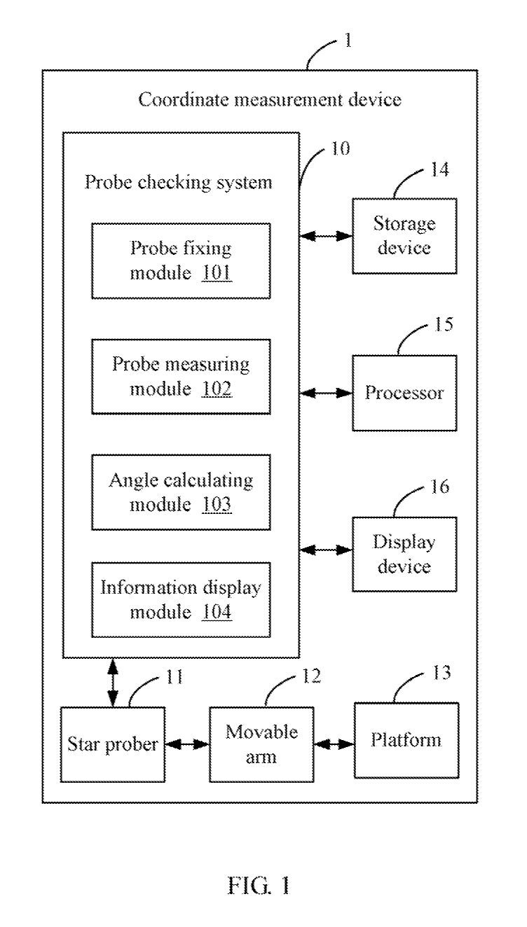

FIG. 1 is a block diagram of one embodiment of a coordinate measurement device 1 including a probe checking system 10. In the embodiment, the coordinate measurement device 1 further includes a star prober 11, a movable arm 12, a platform 13, a storage device 14, at least one processor 15, and a display device 16. The probe checking system 10 may include a plurality of functional modules that are stored in the storage device 14 and executed by the processor 15. FIG. 1 is only one example of the coordinate measurement device 1, other examples may include more or fewer components than those shown in the embodiment, or have a different configuration of the various components.

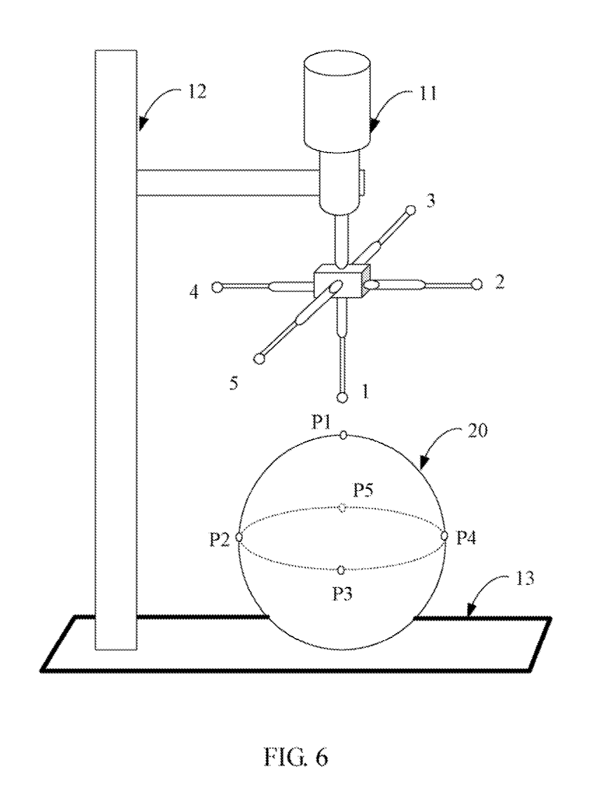

FIG. 6 shows one embodiment of a schematic diagram of the star prober 11. In the embodiment, the star prober 11 includes five probes that are respectively named as a first probe, a second probe, a third probe, a fourth probe, and a fifth probe. The first probe is installed on the star prober 11 vertically, pointing downwards, and is at ninety degrees to other probes installed on the star prober 11. The star prober 11 can be moved towards a standard ball 20 that is placed on the platform 13, and measure coordinates of all points on the standard ball 20 using the respective probe. For example, the star prober 11 measures a coordinate value of a first point P1 on a top surface of the standard ball 20 using the first probe, measures a coordinate value of a second point P2 on a left surface of the standard ball 20 using the second probe, measures a coordinate value of a third point P3 on a front surface of the standard ball 20 using the third probe, measures a coordinate value of a fourth point P4 on a right surface of the standard ball 20 using the fourth probe, and measures a coordinate value of a fifth point P5 on a back surface of the standard ball 20 using the fifth probe.

The movable arm 12 is configured to vertically fix the star prober 11 on the platform 13, and the standard ball 20 is horizontally placed on the platform 13. The movable arm 12 controls the star prober 11 to move in different directions, so as to make the star prober 11 conveniently measure coordinates of different points of the standard ball 20.

In one embodiment, the storage device 14 may be an internal storage device, such as a random access memory (RAM) for temporary storage of information, and/or a read only memory (ROM) for permanent storage of information. The storage device 14 may also be an external storage device, such as an external hard disk, a storage card, or a non-transitory storage medium. The at least one processor 15 is a central processing unit (CPU) or microprocessor that performs various functions of the coordinate measurement device 1.

In one embodiment, the probe checking system 10 includes a probe fixing module 101, a probe measuring module 102, an angle calculating module 103, and an information display module 104. The modules 101-104 may comprise computerized instructions in the form of one or more programs that are stored in the storage device 14 and executed by the at least one processor 15.

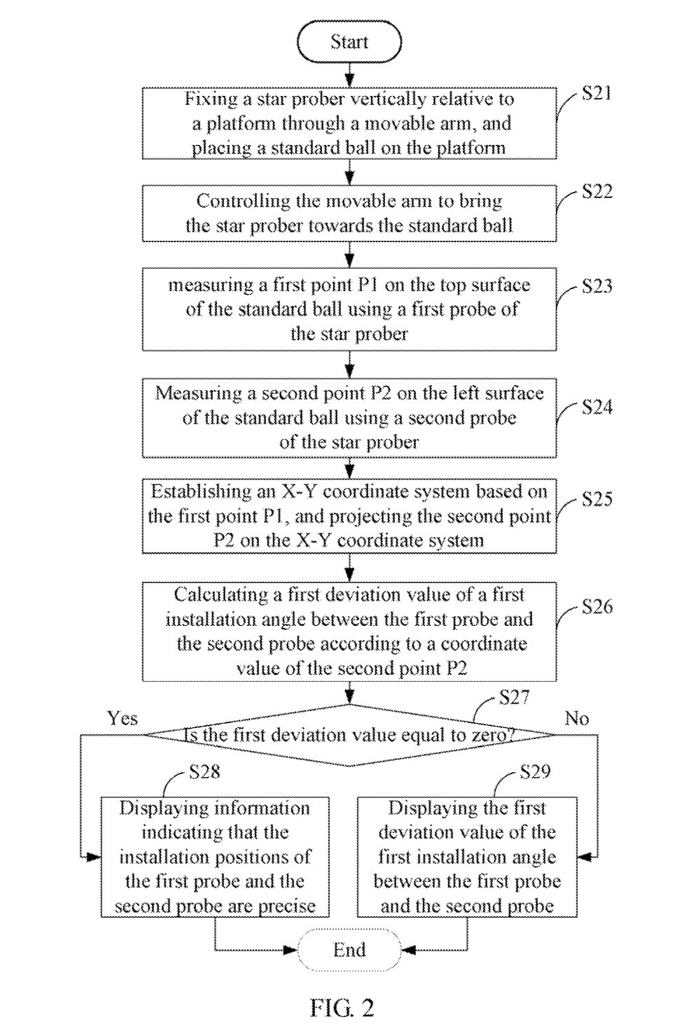

FIG. 2 is a flowchart of one embodiment of a method for checking installation positions of the first probe and the second probe installed on the star prober 11. Depending on the embodiment, additional steps may be added, others removed, and the ordering of the steps may be changed.

In step S21, the probe fixing module 101 fixes the star prober 11 vertically relative to the platform 13 through the movable arm 12, and places the standard ball 20 on the platform 13. Referring to FIG. 6, the movable arm 12 vertically fixes the star prober 11 on the platform 13, and the standard ball 20 is placed on the platform 13.

In step S22, the probe fixing module 101 controls the movable arm 12 to bring the star prober 11 towards the standard ball 20. Referring to FIG. 6, the movable arm 12 controls the star prober 11 to move towards the standard ball 20 placed on the platform 13.

In step S23, the probe measuring module 102 measures a first point P1 on the top surface of the standard ball 20 using the first probe of the star prober 11. Referring to FIG. 6, a coordinate value of the first point P1 on the top surface of the standard ball 20 is measured by the first probe of the star prober 11.

In step S24, the probe measuring module 102 measures a second point P2 on the left surface of the standard ball 20 using a second probe of the star prober 11. Referring to FIG. 6, a coordinate value of the second point P2 on the top surface of the standard ball 20 is measured by the second probe of the star prober 11.

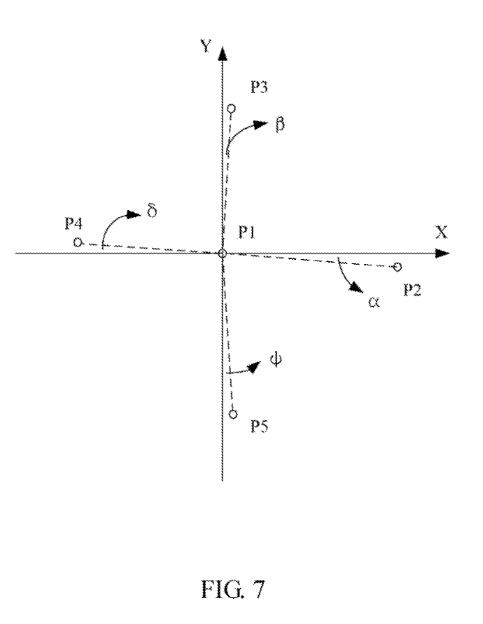

In step S25, the angle calculating module 103 establishes an X-Y coordinate system based on the first point P1, and projects the second point P2 on the X-Y coordinate system. Referring to FIG. 7, the center point (0, 0) of the X-Y coordinate system is the first point P1(X1, Y1), and the coordinate value of the second point P2 is denoted as (X2, Y2).

In step S26, the angle calculating module 103 calculates a first deviation value of the first installation angle between the first probe and the second probe according to the coordinate value of the second point P2. Referring to FIG. 7, the first deviation value of the first installation angle between the first probe and the second probe is denoted as an angle α=arctan((Y2-Y1)/(X2-X1)), such as α=−0.0224.

In step S27, the angle calculating module 103 determines whether the first deviation value of the first installation angle is equal to zero. If the first deviation value of the first installation angle is equal to zero, step S28 is implemented. If the first deviation value of the first installation angle is not equal to zero, step S29 is implemented.

In step S28, the information display module 104 displays information on the display device 16 for indicating that the installation positions of the first probe and the second probe are sufficiently precise.

In step S29, the information display module 104 displays information on the display device 16 for indicating that the installation positions of the first probe and the second probe are not precise, and displays the first deviation value of the first installation angle between the first probe and the second probe on the display device 16.

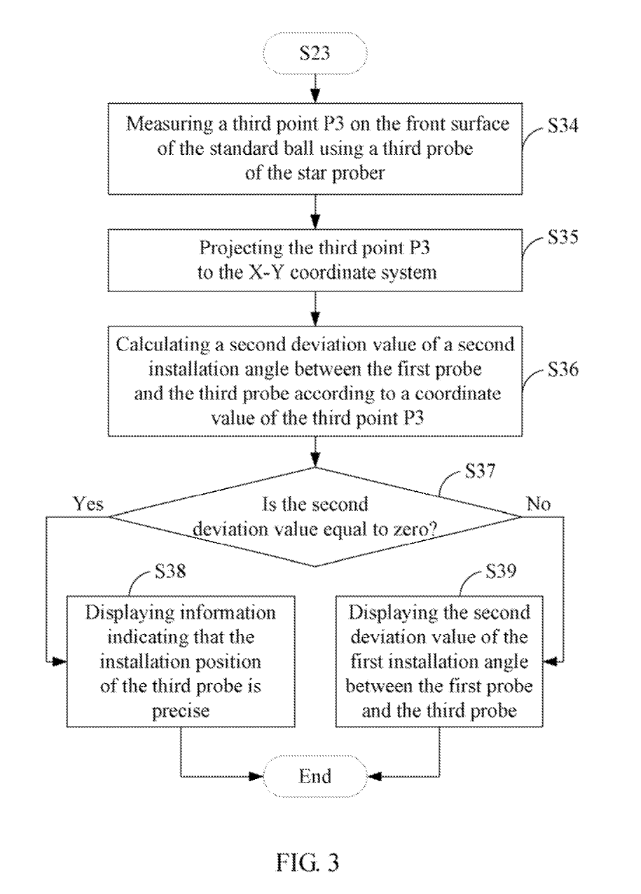

FIG. 3 is a flowchart of one embodiment of a method for checking an installation of the third probe installed on the star prober 11. Depending on the embodiment, additional steps may be added, others removed, and the ordering of the steps may be changed.

In step S34, the probe measuring module 102 measures a third point P3 on the front surface of the standard ball 20 using the third probe of the star prober 11. Referring to FIG. 6, a coordinate value of the third point P3 on the top surface of the standard ball 20 is measured by the third probe of the star prober 11.

In step S35, the angle calculating module 103 projects the third point P3 on the X-Y coordinate system. Referring to FIG. 7, the coordinate value of the third point P3 is denoted as (X3, Y3).

In step S36, the angle calculating module 103 calculates a second deviation value of the second installation angle between the first probe and the third probe according to the coordinate value of the third point P3. Referring to FIG. 7, the second deviation value of the second installation angle between the first probe and the third probe is denoted as an angle β=arctan((Y3-Y1)/(X3-X1)), such as β=0.2528.

In step S37, the angle calculating module 103 determines whether the second deviation value of the second installation angle is equal to zero. If the second deviation value of the second installation angle is equal to zero, step S38 is implemented. If the second deviation value of the second installation angle is not equal to zero, step S39 is implemented.

In step S38, the information display module 104 displays information on the display device 16 for indicating that the installation position of the third probe is precise.

In step S39, the information display module 104 displays information on the display device 16 for indicating that the installation position of the third probe is not precise, and displays the second deviation value of the second installation angle between the first probe and the third probe on the display device 16.

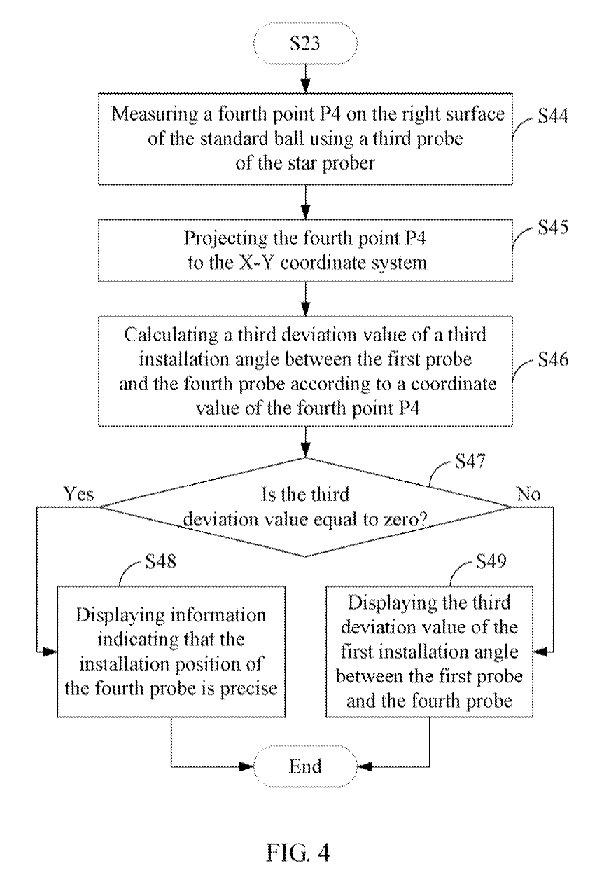

FIG. 4 is a flowchart of one embodiment of a method for checking an installation position of the fourth probe installed on the star prober 11. Depending on the embodiment, additional steps may be added, others removed, and the ordering of the steps may be changed.

In step S44, the probe measuring module 102 measures a fourth point P4 on the right surface of the standard ball 20 using the fourth probe of the star prober 11. Referring to FIG. 6, a coordinate value of the fourth point P4 on the top surface of the standard ball 20 is measured by the fourth probe of the star prober 11.

In step S45, the angle calculating module 103 projects the fourth point P4 on the X-Y coordinate system. Referring to FIG. 7, the coordinate value of the fourth point P4 is denoted as (X4, Y4).

In step S46, the angle calculating module 103 calculates a third deviation value of the third installation angle between the first probe and the fourth probe according to the coordinate value of the fourth point P4. Referring to FIG. 7, the third deviation value of the third installation angle between the first probe and the fourth probe is denoted as an angle δ=arctan((Y4-Y1)/(X4-X1)), such as δ=0.2528.

In step S47, the angle calculating module 103 determines whether the third deviation value of the third installation angle is equal to zero. If the third deviation value of the third installation angle is equal to zero, step S48 is implemented. If the third deviation value of the third installation angle is not equal to zero, step S49 is implemented.

In step S48, the information display module 104 displays information on the display device 16 for indicating that the installation position of the fourth probe is precise.

In step S49, the information display module 104 displays information on the display device 16 for indicating that the installation position of the fourth probe is not precise, and displays the third deviation value of the third installation angle between the first probe and the fourth probe on the display device 16.

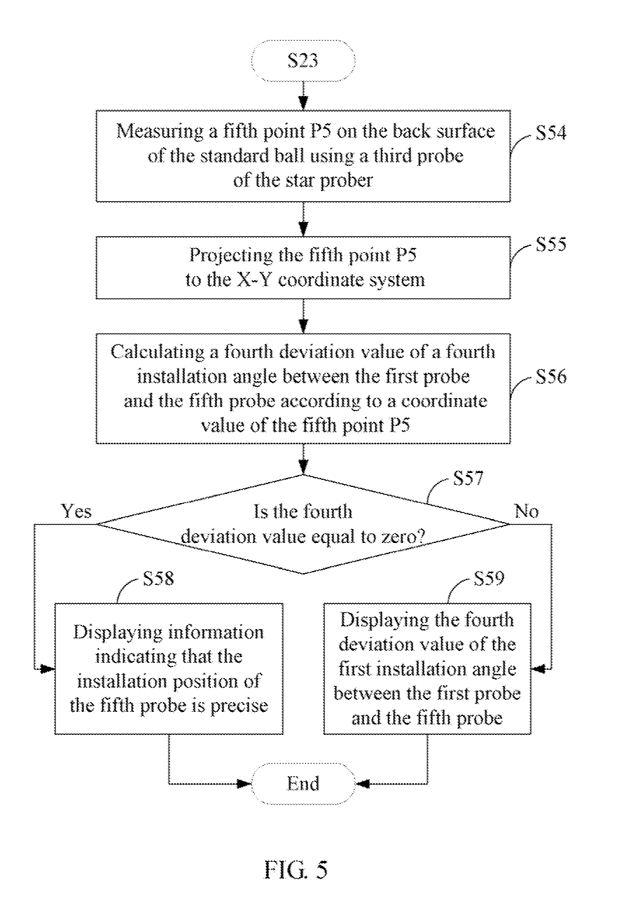

FIG. 5 is a flowchart of one embodiment of a method for checking an installation position of the fifth probe installed on the star prober 11. Depending on the embodiment, additional steps may be added, others removed, and the ordering of the steps may be changed.

In step S54, the probe measuring module 102 measures a fifth point P5 on the back surface of the standard ball 20 using the fifth probe of the star prober 11. Referring to FIG. 6, a coordinate value of the fifth point P5 on the top surface of the standard ball 20 is measured by the fifth probe of the star prober 11.

In step S55, the angle calculating module 103 projects the fifth point P5 on the X-Y coordinate system. Referring to FIG. 7, the coordinate value of the fifth point P5 is denoted as (X5, Y5).

In step S56, the angle calculating module 103 calculates a fourth deviation value of the fourth installation angle between the first probe and the fifth probe according to the coordinate value of the fifth point P5. Referring to FIG. 7, the fourth deviation value of the fourth installation angle between the first probe and the fifth probe is denoted as an angle φ=arctan((Y5-Y1)/(X5-X1)), such as φ=0.2528.

In step S57, the angle calculating module 103 determines whether the fourth deviation value of the fourth installation angle is equal to zero. If the fourth deviation value of the fourth installation angle is equal to zero, step S58 is implemented. If the fourth deviation value of the fourth installation angle is not equal to zero, step S59 is implemented.

In step S58, the information display module 104 displays information on the display device 16 for indicating that the installation position of the fifth probe is precise.

In step S59, the information display module 104 displays information on the display device 16 for indicating that the installation position of the fifth probe is not precise, and displays the fourth deviation value of the fourth installation angle between the first probe and the fifth probe on the display device 16.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A coordinate measurement device, comprising:
a star prober, a movable arm, a platform, a display device, and at least one processor; and
a storage device storing a computer-readable program including instructions that, which when executed by the at least one processor, causes the at least one processor to:
fix the star prober vertically relative to the platform through the movable arm, and place a standard ball on the platform;
control the movable arm to bring the star prober towards the standard ball;
measure a first point on a top surface of the standard ball using a first probe of the star prober;
measure a second point on a left surface of the standard ball using a second probe of the star prober;
establish an X-Y coordinate system based on the first point, and project the second point on the X-Y coordinate system;
calculate a first deviation value of a first installation angle between the first probe and the second probe according to a coordinate value of the second point;
determine whether the first deviation value of the first installation angle is equal to zero;
display information on the display device for indicating that the installation positions of the first probe and the second probe are precise, when the first deviation value of the first installation angle is equal to zero; and
display information on the display device for indicating that the installation positions of the first probe and the second probe are not precise when the first deviation value of the first installation angle is not equal to zero, and display the first deviation value of the first installation angle between the first probe and the second probe on the display device.

2. The coordinate measurement device according to claim 1, wherein the computer-readable program further causes the at least one processor to:
measure a third point on a front surface of the standard ball using a third probe of the star prober, and project the third point on the X-Y coordinate system;
calculate a second deviation value of a second installation angle between the first probe and the third probe according to a coordinate value of the third point;
determine whether the second deviation value of the second installation angle is equal to zero;
display information on the display device for indicating that an installation position of the third probe is precise, when the second deviation value of the second installation angle is equal to zero; and
display information on the display device for indicating that the installation position of the third probe is not precise when the second deviation value of the second installation angle is not equal to zero, and display the second deviation value of the second installation angle between the first probe and the third probe on the display device.

3. The coordinate measurement device according to claim 1, wherein the computer-readable program further causes the at least one processor to:
measure a fourth point on a right surface of the standard ball using a fourth probe of the star prober, and project the fourth point on the X-Y coordinate system;
calculate a third deviation value of a third installation angle between the first probe and the fourth probe according to a coordinate value of the fourth point;
determine whether the third deviation value of the third installation angle is equal to zero;
display information on the display device for indicating that an installation position of the fourth probe is precise, when the third deviation value of the third installation angle is equal to zero; and
display information on the display device for indicating that the installation position of the fourth probe is not precise when the third deviation value of the third installation angle is not equal to zero, and display the third deviation value of the third installation angle between the first probe and the fourth probe on the display device.

4. The coordinate measurement device according to claim 1, wherein the computer-readable program further causes the at least one processor to:
measure a fifth point on a back surface of the standard ball using a fifth probe of the star prober, and project the fifth point on the X-Y coordinate system;
calculate a fourth deviation value of a fourth installation angle between the first probe and the fifth probe according to a coordinate value of the fifth point;
determine whether the fourth deviation value of the fourth installation angle is equal to zero;
display information on the display device for indicating that an installation position of the fifth probe is precise, when the fourth deviation value of the fourth installation angle is equal to zero; and
display information on the display device for indicating that the installation position of the fifth probe is not precise when the fourth deviation value of the fourth installation angle is not equal to zero, and display the fourth deviation value of the fourth installation angle between the first probe and the fifth probe on the display device.

5. The coordinate measurement device according to claim 1, wherein the star prober includes five probes for measuring various points of the standard ball, and the first probe is installed on star prober in a downwards pointing position and is perpendicular to other probes of the star prober.

6. The coordinate measurement device according to claim 1, wherein the movable arm controls the star prober to move towards the standard ball that is horizontally placed on the platform.

7. A method for checking installation positions of probes of a star prober using a coordinate measurement device, the coordinate measurement device comprising a movable arm, a platform and a display device, the method comprising:
fixing the star prober vertically relative to the platform through the movable arm, and placing a standard ball on the platform;
controlling the movable arm to bring the star prober towards the standard ball;
measuring a first point on a top surface of the standard ball using a first probe of the star prober;
measuring a second point on a left surface of the standard ball using a second probe of the star prober;
establishing an X-Y coordinate system based on the first point, and projecting the second point on the X-Y coordinate system;
calculating a first deviation value of a first installation angle between the first probe and the second probe according to a coordinate value of the second point;
determining whether the first deviation value of the first installation angle is equal to zero;
displaying information on the display device for indicating that the installation positions of the first probe and the second probe are precise, when the first deviation value of the first installation angle is equal to zero; and
displaying information on the display device for indicating that the installation positions of the first probe and the second probe are not precise when the first deviation value of the first installation angle is not equal to zero, and displaying the first deviation value of the first installation angle between the first probe and the second probe on the display device.

8. The method according to claim 7, further comprising:
measuring a third point on a front surface of the standard ball using a third probe of the star prober, and projecting the third point on the X-Y coordinate system;
calculating a second deviation value of a second installation angle between the first probe and the third probe according to a coordinate value of the third point;
determining whether the second deviation value of the second installation angle is equal to zero;
displaying information on the display device for indicating that an installation position of the third probe is precise, when the second deviation value of the second installation angle is equal to zero; and
displaying information on the display device for indicating that the installation position of the third probe is not precise when the second deviation value of the second installation angle is not equal to zero, and displaying the second deviation value of the second installation angle between the first probe and the third probe on the display device.

9. The method according to claim 7, further comprising:
measuring a fourth point on a right surface of the standard ball using a fourth probe of the star prober, and projecting the fourth point on the X-Y coordinate system;
calculating a third deviation value of a third installation angle between the first probe and the fourth probe according to a coordinate value of the fourth point;
determining whether the third deviation value of the third installation angle is equal to zero;
displaying information on the display device for indicating that an installation position of the fourth probe is precise, when the third deviation value of the third installation angle is equal to zero; and
displaying information on the display device for indicating that the installation position of the fourth probe is not precise when the third deviation value of the third installation angle is not equal to zero, and displaying the third deviation value of the third installation angle between the first probe and the fourth probe on the display device.

10. The method according to claim 7, further comprising:
measuring a fifth point on a back surface of the standard ball using a fifth probe of the star prober, and projecting the fifth point on the X-Y coordinate system;
calculating a fourth deviation value of a fourth installation angle between the first probe and the fifth probe according to a coordinate value of the fifth point;
determining whether the fourth deviation value of the fourth installation angle is equal to zero;
displaying information on the display device for indicating that an installation position of the fifth probe is precise, when the fourth deviation value of the fourth installation angle is equal to zero; and
displaying information on the display device for indicating that the installation position of the fifth probe is not precise when the fourth deviation value of the fourth installation angle is not equal to zero, and displaying the fourth deviation value of the fourth installation angle between the first probe and the fifth probe on the display device.

11. The method according to claim 7, wherein the star prober includes five probes for measuring various points of the standard ball, and the first probe is installed on star prober in a downwards pointing position and is perpendicular to other probes of the star prober.

12. The method according to claim 7, wherein the movable arm controls the star prober to move towards the standard ball that is horizontally placed on the platform.

13. A non-transitory computer-readable storage medium having stored thereon instructions that, when executed by at least one processor of a coordinate measurement device, causes the at least one processor to perform a method for checking installation positions of probes of a star prober, the coordinate measurement device comprising a movable arm, a platform and a display device, the method comprising:
fixing the star prober vertically relative to the platform through the movable arm, and placing a standard ball on the platform;
controlling the movable arm to bring the star prober towards the standard ball;
measuring a first point on a top surface of the standard ball using a first probe of the star prober;
measuring a second point on a left surface of the standard ball using a second probe of the star prober;
establishing an X-Y coordinate system based on the first point, and projecting the second point on the X-Y coordinate system;
calculating a first deviation value of a first installation angle between the first probe and the second probe according to a coordinate value of the second point;
determining whether the first deviation value of the first installation angle is equal to zero;
displaying information on the display device for indicating that the installation positions of the first probe and the second probe are precise, when the first deviation value of the first installation angle is equal to zero; and
displaying information on the display device for indicating that the installation positions of the first probe and the second probe are not precise when the first deviation value of the first installation angle is not equal to zero, and displaying the first deviation value of the first installation angle between the first probe and the second probe on the display device.

14. The storage medium according to claim 13, wherein the method further comprises:
measuring a third point on a front surface of the standard ball using a third probe of the star prober, and projecting the third point on the X-Y coordinate system;
calculating a second deviation value of a second installation angle between the first probe and the third probe according to a coordinate value of the third point;
determining whether the second deviation value of the second installation angle is equal to zero;
displaying information on the display device for indicating that an installation position of the third probe is precise, when the second deviation value of the second installation angle is equal to zero; and
displaying information on the display device for indicating that the installation position of the third probe is not precise when the second deviation value of the second installation angle is not equal to zero, and displaying the second deviation value of the second installation angle between the first probe and the third probe on the display device.

15. The storage medium according to claim 13, wherein the method further comprises:
measuring a fourth point on a right surface of the standard ball using a fourth probe of the star prober, and projecting the fourth point on the X-Y coordinate system;
calculating a third deviation value of a third installation angle between the first probe and the fourth probe according to a coordinate value of the fourth point;
determining whether the third deviation value of the third installation angle is equal to zero;
displaying information on the display device for indicating that an installation position of the fourth probe is precise, when the third deviation value of the third installation angle is equal to zero; and
displaying information on the display device for indicating that the installation position of the fourth probe is not precise when the third deviation value of the third installation angle is not equal to zero, and displaying the third deviation value of the third installation angle between the first probe and the fourth probe on the display device.

16. The storage medium according to claim 13, wherein the method further comprises:
measuring a fifth point on a back surface of the standard ball using a fifth probe of the star prober, and projecting the fifth point on the X-Y coordinate system;
calculating a fourth deviation value of a fourth installation angle between the first probe and the fifth probe according to a coordinate value of the fifth point;
determining whether the fourth deviation value of the fourth installation angle is equal to zero;
displaying information on the display device for indicating that an installation position of the fifth probe is precise, when the fourth deviation value of the fourth installation angle is equal to zero; and
displaying information on the display device for indicating that the installation position of the fifth probe is not precise when the fourth deviation value of the fourth installation angle is not equal to zero, and displaying the fourth deviation value of the fourth installation angle between the first probe and the fifth probe on the display device.

17. The storage medium according to claim 13, wherein the star prober includes five probes for measuring various points of the standard ball, and the first probe is installed on star prober in a downwards pointing position and is perpendicular to other probes of the star prober.

18. The storage medium according to claim 13, wherein the movable arm controls the star prober to move towards the standard ball that is horizontally placed on the platform.
